(19) United States
(12) Patent Application Publication
(10) Pub. No.: US 2005/0178898 A1
(43) Pub. Date: Aug. 18, 2005

(54) Method and apparatus for controlling an airplane

(76) Inventor: Shun Ming Yuen, Hong Kong (HK)

Correspondence Address: MORRISON & FOERSTER, LLP, 555 WEST FIFTH STREET, SUITE 3500, LOS ANGELES, CA, 90013-1024, US

(21) Appl. No.: 11/046,505

(22) Filed: Jan. 28, 2005

Related U.S. Application Data
(63) Continuation-in-part of application No. 29/210,340, filed on Jul. 28, 2004.

(30) Foreign Application Priority Data
Jan. 28, 2004 (HK) 0410205.1M001

(51) Int. Cl. B64C 13/00

(52) U.S. Cl. 244/75 R

(57) ABSTRACT

The present invention is directed a method and apparatus for controlling the light of an airplane, such as a remote controlled airplane. Specifically, on an airplane having a tail section that includes stabilizers and elevators, the preferred embodiments of the present invention includes elevator adjusting mechanism, preferably affixed to the underside of the stabilizers, for adjusting the pitch angle of the elevators with respect to the stabilizers so as to help maintain the balance and stability of the airplane during normal course of flying. The present invention also includes cable wheels for rotatably attaching control cables to the elevators, wherein the cables are controlled by a servomechanism to actuate the elevators, and wherein the wheels can be adjusted so as to maintain proper tension in the control cables.

### BACKGROUND

1. Field of Invention

Preferred embodiments of the present invention are directed to a method and apparatus for controlling the flight of an airplane, such as a toy model airplane.

2. Description of Related Art

The present invention is directed to an improved method of controlling the flight of an airplane. Specifically, preferred embodiments of the present invention provides for fine adjustments to the rear elevators of a model or toy airplane so as to compensate for any tendencies to deviate from a normal course of flight.

FIGS. 1 and 2 illustrate a conventional remote control airplane 1 includes a fixed wing 2, an electrically powered propeller 3, a body 90, and a V-shaped tail with rear stabilizers 8 and 9, rear elevators 12 and 13, and cables 4 and 5 that connect between a servomechanism 20, which is in this instanced located within a remote control receiving device 21, with the rear elevators 12 and 13. When in operation, the remote control airplane 1 responds to remote control radio signals for, e.g., turning left or right by actuating the rear elevators 12 and 13 via cables 4 and 5. Specifically, if a signal for right turn is received, the servomechanism will cause the pulling of cable 5 so as to pull upwards the right rear elevator 13, causing the plane to turn right. It is also understood that both elevators can be actuated at the same time so as to affect the pitch of the plane and therefore affect upward or downward flight direction of the plane. Restoring means 6 and 7, which can be a rubber element connecting the rear stabilizer 8, 9 and the elevators 12, 13, respectively, will counter the pulling force of the cables 4 and 5 such that, when there is no tensions in cables 4 and 5 caused by the servo mechanism, the restoring means will return the elevators to their respective normal position.

FIGS. 3 and 4 show additional illustration of the restoring means. As shown in FIG. 3, restoring means is a rubber element 7 that attaches between the right rear elevator 13 and the right rear stabilizer 9. Surfaces 30 and 31 are smooth as shown. FIG. 4 shows an alternative way of implementing the restoring means 42, which is a single rubber element that is anchored at the tail 43 of the boy 90, and attached to the elevators 12′ and 13′ of stabilizers 8′ and 9′ via anchors 44 and 45, respectively. Again, surfaces 40 and 41 are shown as smooth surfaces.

Additional details of the conventional remote controlled airplane are discussed in U.S. Pat. No. 6,520,823, the entire contents of which are hereby incorporated by reference.

One disadvantage associated with the conventional remote control airplane 1 described above is that, due to a variety, of factors such as potential uneven distribution of body weight, possibly caused by varying density of the material used to construct the remote control airplane (e.g., wood material used for constructing the wing 2 or differences in balance of weight as a result of production disparities), the plane will not flight straight under normal circumstances even when the rear elevators are not actuated. This problem is especially apparent if the restoring means's counter force is greater than the tension of the cables so as to cause the elevators to be in an uneven position when the cables are not actively controlled.

In situations where the control cables 4 and 5 are actually made of a single continuous cable that is anchored at the servomechanism, the servomechanism simply rotates to the left or to the right to actuate the elevators (see, e.g., Col. 3, lines 14-33 of U.S. Pat. No. 6,520,823). However, in such an implementation, pulling of one control cable, e.g., cable 4, would cause slack to the other control cable 5. As a result, the slack in control cable 5 would allow elevator 13 to be pulled downwards by the restoring means (e.g. rubber band) 7, as shown in FIGS. 8a-8c. This may cause a greater than intended reduction in the turning radius of the plane, and may cause the plain to over steer and hence spiral downwards. The only way to prevent this scenario from happening would require that adjacent surfaces adjoining the elevator and the stabilizer, such as surfaces 30 and 31 in FIG. 3, are flat and can lean against each other (as discussed in Col. 3, lines 23-24 of U.S. Pat. No. 6,520,823). However, requiring the adjoining surfaces to lean against each other when in a normal flight position would limit the ability of the elevators to he adjusted downwards, and hence would hinder efforts to control the pitch of the plane during flight.

### SUMMARY OF THE INVENTION

It is an object of the present invention to provide a method and apparatus to improve flight control, balance, and/or stability of an airplane during flight, such as the flight of a remotely controlled model airplane. In accordance with a preferred embodiment of the present invention, adjusting means such as screws are provided at the underside of the rear stabilizers and the rear elevators of the remote control airplane 1 so as to allow a user to adjust the normal position of the elevators when the elevators are not actuated.

In accordance with the another embodiment of the invention, control cables for controlling the rear elevators of a remote control airplane is attached to the elevators via a spool or a wheel that is rotatably attached to a fixing base affixed on the elevator, wherein the wheel can be, in one embodiment, rotatably attached to the anchor via a rotational resistive element, such as rubber, mechanical spring, etc. so as to maintain a tension on the control cable at all times.

### BRIEF DESCRIPTION OF THE DRAWINGS

FIG. 1 is a schematic illustration of a conventional remote control airplane known in the art;

FIG. 2 is another schematic illustration of a conventional remote control airplane of FIG. 1;

FIG. 3 is a detailed schematic illustration of a rear stabilizer and rear elevator of the conventional remote control airplane of FIG. 1;

FIG. 4 is a detailed schematic illustration of rear stabilizer and rear elevator of the conventional remote control airplane in accordance with an alternative implementation;

FIG. 5 is a schematic illustration of the underside of the tail of an airplane in accordance with a preferred embodiment of the present invention;

FIG. 6 is a perspective view of the tail of the airplane in accordance with the preferred embodiment of the present invention;

FIG. 7 is a rear view of the tail of the airplane in accordance with the preferred embodiment of the present invention;

FIG. 8a is rear view of the tail section of the airplane in accordance an alternative embodiment of the present invention;

FIG. 8b is a side view of the tail section of FIG. 8a;

FIG. 8c is a top view of the tail section of FIG. 8a.

### DETAILED DESCRIPTION OF THE EMBODIMENTS

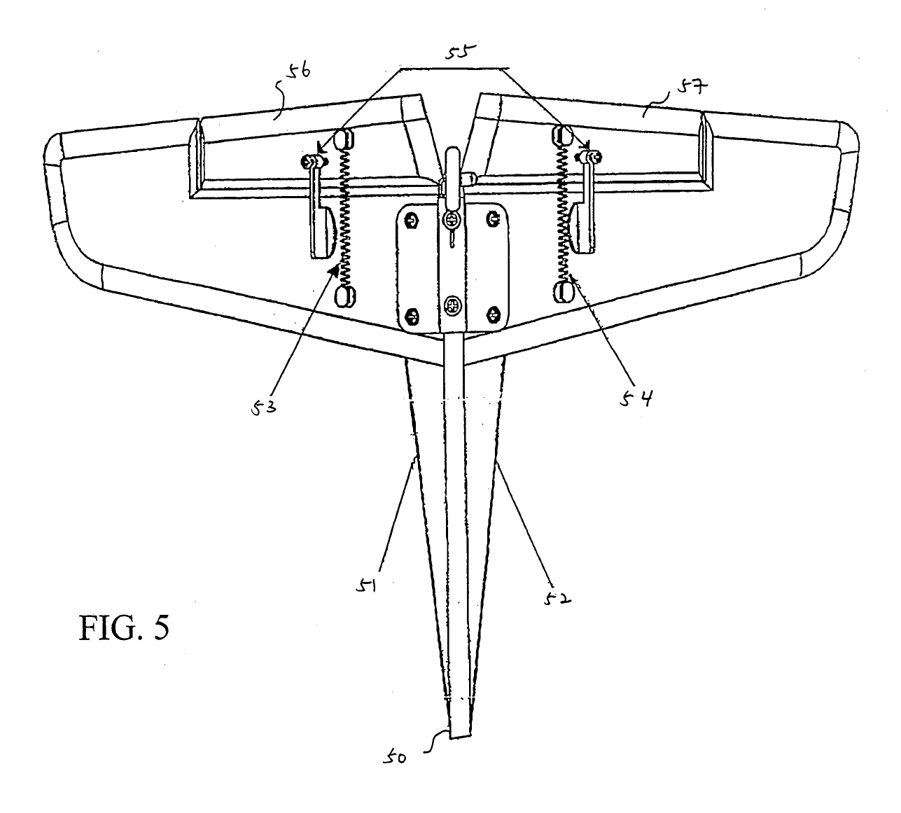

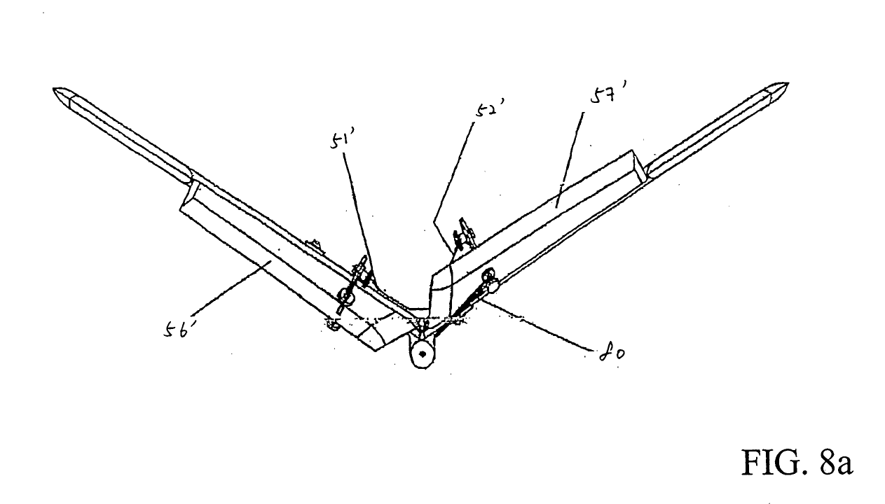

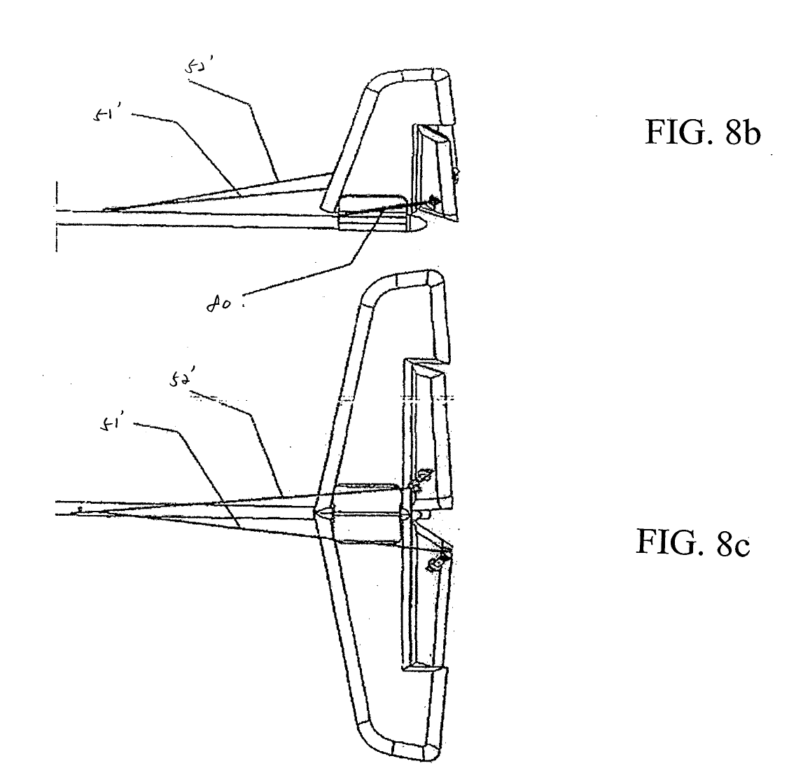

Details of the embodiments of the present invention will now be described with references to FIGS. 5-8c.

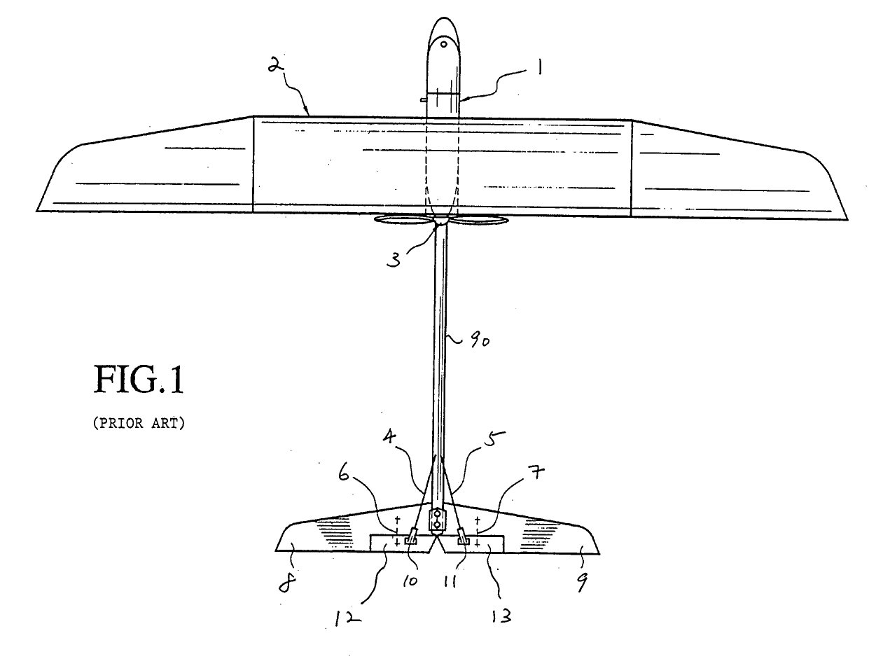

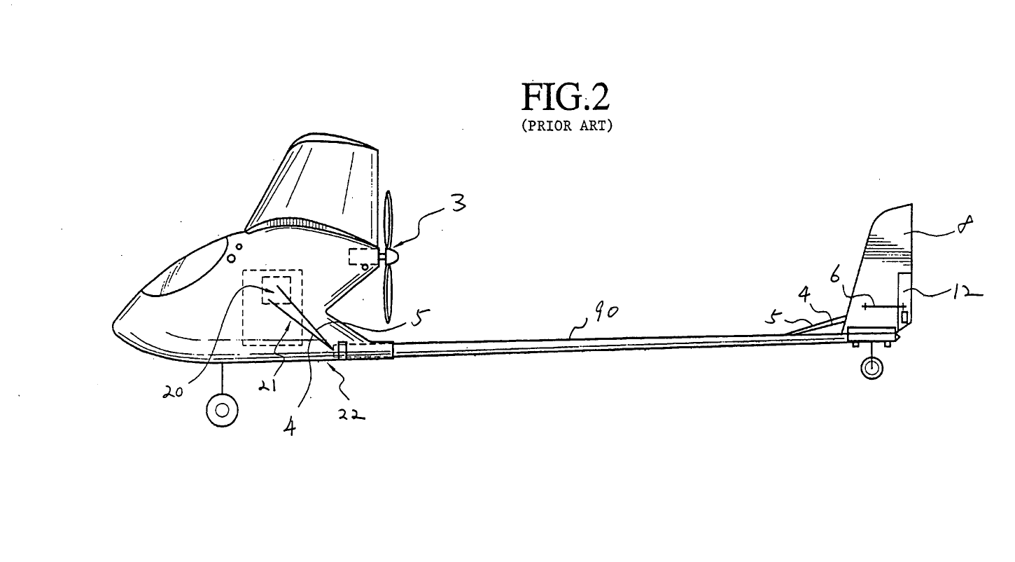

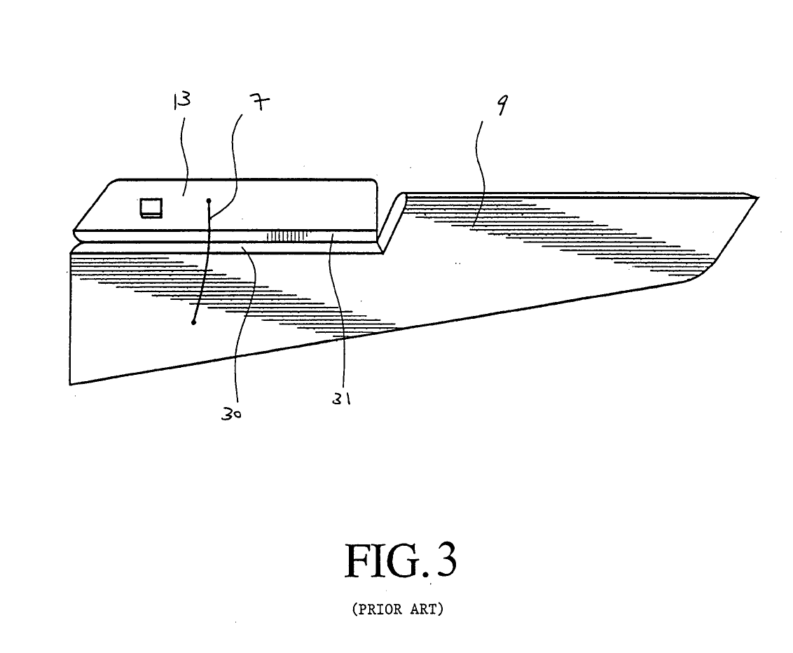

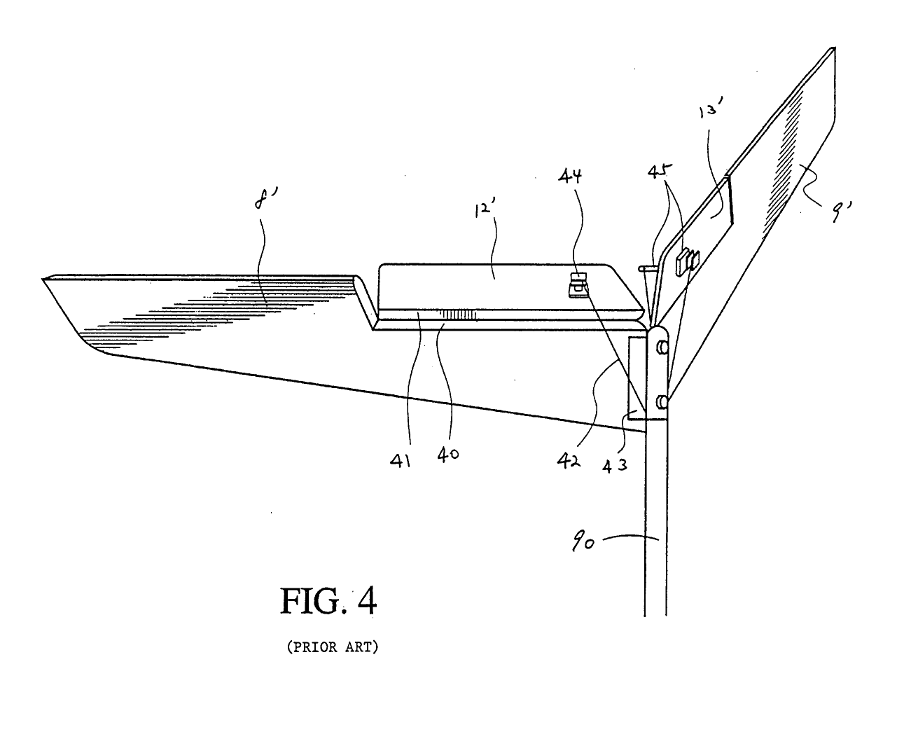

FIGS. 5-7 show the tail portion of a toy airplane in accordance with a preferred embodiment of the present invention. Although the front portion of the airplane is not shown, one skilled in the art understands that a variety of different designs can be used in conjunction with the tail construction shown in FIG. 5. For purposes of illustration, the front of the airplane can be of the same construction as the conventional remote control airplane 1 shown in FIGS. 1 and 2. As shown in FIGS. 5-7, a body 50 attached to a pair of rear stabilizers having elevators 56 and 57. As it is well understood, elevators are used to control the pitch and turn of an airplane. In accordance with the preferred embodiment, the elevators can be controlled via cables 51 and 52. As discussed above, cables 51 and 52 can be controlled (e.g., pulled) by a servomechanism in response to a control signal received from remote control device. Restoring means 53 and 54 are shown as being attached to the stabilizers, on the one end, and the underside of the elevators, on the other end. The restoring means are preferably made of resistive material such as, in the case of FIGS. 5-7, a mechanical spring, but can also be made of rubber band material.

As also shown in FIGS. 5-7, elevator pitch adjusting mechanism 55 and 63 are provided to allow for fine adjustment of the elevators. Specifically, adjustment supports 63 are attached to the under surface of the stabilizers, and through which an adjustment screw 55 is inserted so as to support the elevator against the force of the restoring springs 53 and 54. The pitch of elevators 56 and 57 can be finely adjusted by rotating the respective adjustment screws 55 clockwise or counterclockwise. These fine adjustments can be made via a series of trial, preferably conducted via powerless throws of the airplane. For instance, in conducting a level test-throw on a powerless airplane, if the airplane has a tendency to deviate to the left after the throw, then adjustments can be made by turning the screw 55 under elevator 57 (right side) in an counterclockwise direction, or turning the screw 55 under elevator 56 (left side) in a clockwise direction. The opposite can be done if the plane deviates to the right on the test throw.

Additionally, if the front of the plane is found to be too heavy during the throw (i.e., the plan tends to deviate downwards), then fine adjustment can be made by turning both screws 55 clockwise to raise both of the elevators. Likewise, if the plane deviates upwards during test flight, both screws 55 can be turned counterclockwise to compensate.

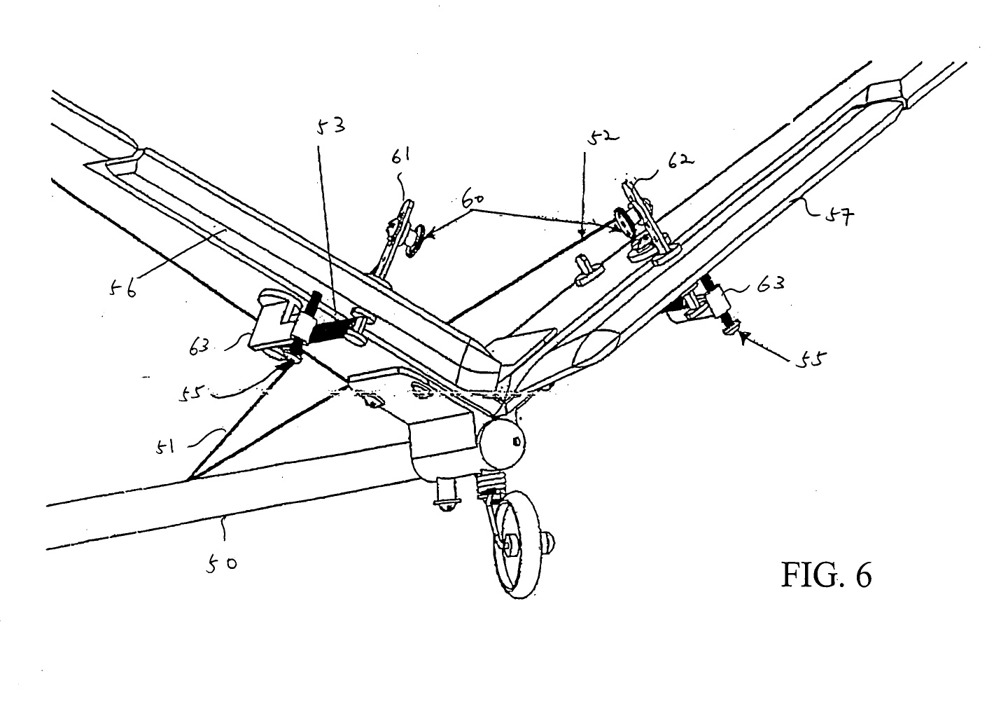

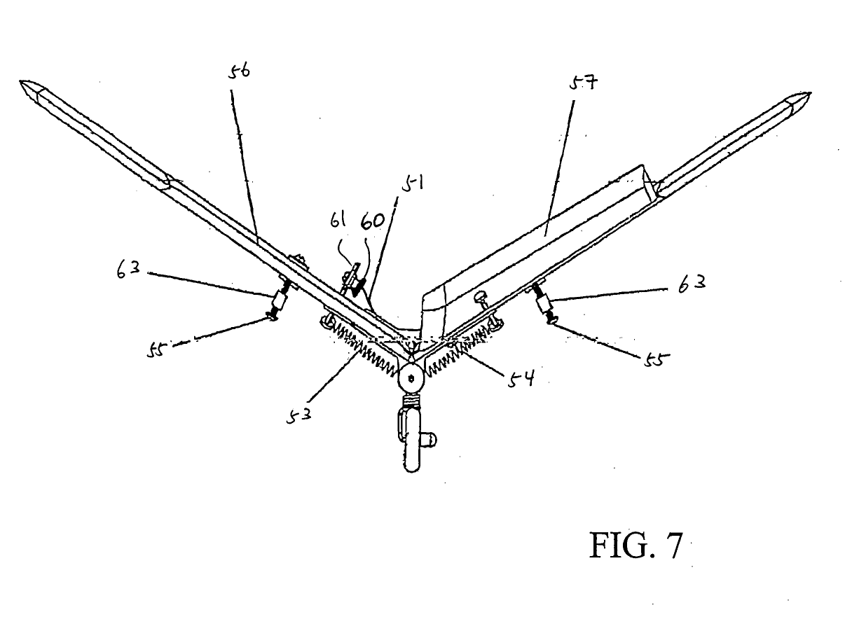

As shown in FIGS. 6 and 7, control cables 51 and 52 are preferably operatively coupled to the elevators 56 and 57, respectively, via wheels 60 and the left and right fixing bases 61 and 62, respectively. Wheels 60 are preferably rotatably attached to the fixing bases 61 and 62 such that the wheels can be turned clockwise or counterclockwise. In one preferred embodiment, the wheels 60 are rotatably attached to the fixing bases 61 and 62 such that the attachment is sufficiently tight so as to maintain the rotational positions of the wheels after fine adjustment. Specifically, a user can adjust the tension of cables 51 and 52 by turning the wheels 60 clockwise or counterclockwise; given the wheels 60 are rotatable about the fixing bases 61 and 62, but at the same time attached sufficiently tight so as to hold the fine adjustment positions, the cable tensions can be finely adjust from time to time to ensure proper cable control.

In accordance with an alternative embodiment, the wheels 60 are attached to fixing bases 61 and 62 via resistive elements such as a spring or a rubber element so as to constantly maintain a proper tension for cables 51 and 52. Specifically, the wheels 60, as a result of being attached to the fixing base 61 and 62 via rotational resistive elements, can act as a retracting mechanism such that anytime there is slack in cables 51 or 52.

It should be understood by one skilled in the art that the above embodiment is discussed for illustrative purposes of the present invention, and should not be interpreted to limit the scope of the present invention. For instance, although FIGS. 5-7 show a V-shaped tail section, the present invention is equally applicable to a standard tail section of a plane having a rudder and two horizontal elevators.

1. A toy airplane comprising:
a body section;
a wing section;
a tail section having a rear stabilizer section, said stabilizer section including a right elevator and a left elevator, said right and left elevators rotatably attached to said stabilizer section;
a right and a left elevator adjusting means, said right and left elevator adjusting means being attached to the underside of said stabilizer section and respective supports said right and left elevators in a prefixed position with respect to the stabilizer section.

2. The toy airplane of claim 1, further comprising:
a servomechanism, said servomechanism being located within said body section;
a control cable that is attached to the upper surface of the right elevator, on the one end, and the upper surface of the left elevator, on the other end, wherein the midpoint of the cable is anchored at the servomechanism,
wherein the servomechanism is operable to control the positions of the right and left elevators by pulling the cable towards the right elevator or towards the left elevator.

3. The toy airplane of claim 1, wherein the adjusting means comprises of an adjustment support and an adjustment screw.

4. The toy airplane of claim 1, wherein the stabilizer section is a V-shaped empennage.

5. The toy airplane of claim 1, further comprising a right and a left restoring means attached to the underside of the stabilizer section for maintaining the elevators at said prefixed position.
